(19) United States
(12) Patent Application Publication
(10) Pub. No.: US 2012/0113250 A1
(43) Pub. Date: May 10, 2012

(54) APPARATUS FOR DETERMINING THE THREE DIMENSIONS OF A PARCEL

(75) Inventors: Laurent FARLOTTI, Pruniers (FR); Ruben RICO, Paris (FR)

(73) Assignee: NEOPOST TECHNOLOGIES, BAGNEUX (FR)

(21) Appl. No.: 13/249,460

(22) Filed: Sep. 30, 2011

(30) Foreign Application Priority Data
Sep. 30, 2010 (EP) 10 306 063.8

(51) Int. Cl. H04N 7/18

(52) U.S. Cl. 348/135; 348/E07.085

(57) ABSTRACT

A method of determining the three dimensions of a parcel, in which method the parcel to be measured is placed against an orthogonal reference support and an image is acquired of said orthogonal reference support having three graduated scales defining the three perpendicular axes of the frame of reference, and a correspondence table is established giving the correspondence between the real distance between each of the graduations of the scales and the corresponding number of pixels of the image, and then an image is acquired of the parcel disposed on the orthogonal reference support, the edges of said parcel are determined along three perpendicular axes, the number of pixels forming each of the edges of the parcel is counted, and a corrector coefficient is applied taken from the correspondence table in order to obtain the looked-for three real dimensions.

### FIELD OF THE INVENTION

The present invention relates to the field of mail handling, and it relates in particular to apparatus for automatically determining the dimensions of a parcel that is then to be franked in a franking system or to be fed into a logistics carriage system.

### PRIOR ART

It is well known that determining the franking amount or “postage amount” for a mailpiece depends on various parameters such as, in particular, the recipient's address, the mail class, the requested service, and the weight or the dimensions of said mailpiece. The address, class, and service may be entered on the keyboard of the franking system, and the weight may be obtained using automatic scales internal or external to the franking system. However, automatically determining the dimensions of the mailpiece is more difficult, in particular when it is a parcel, and such automatic determination of the dimensions usually requires ultrasound systems or light-emitting diode (LED) systems, for example.

Unfortunately, such systems are relatively costly and use of them is justified only for large franking volumes and can hardly be entertained in bottom-of-the-range (low-cost) franking systems designed to frank from one to a few tens of parcels per day. Another limitation on such systems is that, in spite of their cost, they take account of only three edges of the parcel. When the parcel is not in the shape of a rectangular block, that can give rise to errors in determining the dimensions of the parcel.

### OBJECT AND DEFINITION OF THE INVENTION

An object of the present invention is thus to remedy the above-mentioned drawbacks and to make it possible, at very low cost, to determine the dimensions of a parcel. An object of the invention is to enable such determination to be performed in a manner that is simple but nevertheless automatic.

These objects are achieved in accordance with the invention by means of apparatus for determining the three dimensions of a parcel, said apparatus comprising:

an orthogonal reference support made up of at least two perpendicular vertical side panels against which said parcel is placed, and having a vertical graduated scale disposed on one of its two adjoining vertical edges, which scale co-operates with two other graduated scales that are horizontal in order to define a three-dimensional rectangular co-ordinate system, each of which other scales is disposed on a horizontal edge of a respective one of said two side panels, which horizontal edges are in contact with a support surface for supporting said parcel;

an image sensor for acquiring an image of said parcel against said orthogonal reference support; and

a processor unit connected to said image sensor for the purpose of determining the three dimensions of said parcel on the basis of said image acquired in this way;

wherein, on the basis of an image of said orthogonal reference support, said processor unit determines firstly a number of pixels corresponding to each of the graduations of said three graduated scales and secondly the edges of the parcel along three perpendicular axes;

and said processor unit includes a correspondence table associating each of said graduations with said number of pixels determined in this way, so as to obtain said three dimensions of said parcel on the basis of a number of pixels corresponding to each of said edges of said parcel.

The presence of graduated scales associated with the image of the parcel makes it possible to perform prior calibration of the image of the support and thus to have a correspondence table subsequently making it possible, in the image of the parcel to be measured, to associate a measurement in millimeters (mm) with each number of pixels forming a respective one of the edges of said parcel.

Advantageously, said correspondence table includes a corrector coefficient associated with each of said graduations and equal to the ratio between said number of pixels and a value in millimeters of said associated graduation.

Preferably, each of said side panels further has a uniform grid system having a predefined interval, and said support surface may be formed by a horizontal floor panel having a uniform grid system having said predefined interval, or by a plain horizontal floor panel not having any grid system.

Advantageously, said image sensor is a webcam provided with a wide-angle lens and with an autofocus system.

Said processor unit may be constituted by either of the following units: a general-purpose computer; and a laptop computer.

The invention also provides an associated method of determining the three dimensions of a parcel, in which method the parcel to be measured is placed against an orthogonal reference support made up of at least two perpendicular vertical side panels and having a vertical graduated scale disposed on one of its two adjoining vertical edges, which scale co-operates with two other graduated scales that are horizontal in order to define a three-dimensional rectangular co-ordinate system, each of which other scales is disposed on a horizontal edge of a respective one of said two side panels, which horizontal edges are in contact with a support surface for supporting said parcel, wherein said method comprises the following steps:

using an image sensor to acquire an image of said orthogonal reference support;

using a processor unit to which said image sensor is connected to determine, on the resulting acquired image, a number of pixels corresponding to each of the graduations of said three graduated scales;

in said processor unit, establishing a correspondence table associating each of said graduations with said number of pixels determined in this way;

using said image sensor to acquire an image of the parcel disposed on said orthogonal reference support;

using said processor unit to determine the edges of the parcel along three perpendicular axes; and

using said processor unit to count the number of pixels forming each of the edges of the parcel, and obtaining the looked-for three real dimensions on the basis of said correspondence table.

Advantageously, said correspondence table associates each of the graduations with a corrector coefficient equal to the ratio between the number of pixels and a value in millimeters of said associated graduation, and the step of using said processor unit to count the number of pixels forming each of the edges of the parcel further comprises applying a corrector coefficient taken from said correspondence table in order to obtain each of the looked-for three real dimensions.

In an alternative or successive implementation in which each of the two side panels further has a uniform grid system that has a predefined interval, the method further comprises a step of determining the outlines of the parcel and of counting the number of intervals of said grid system of the orthogonal reference support surrounding the parcel in order to obtain at least one dimension of said parcel.

By making this second counting step systematic, it is possible to verify that the parcel is substantially in the shape of a rectangular block. In the event that the measurement of the parallel edges differs significantly, the processor unit can be programmed to take account of the minimum value, of the maximum value, of the mean value, or of any other value determined on the basis of the measured values, as a function of the specifications of the carrier.

### BRIEF DESCRIPTION OF THE DRAWINGS

Other characteristics and advantages of the invention appear from the following description of particular embodiments, given by way of example, and with reference to the accompanying drawings, in which:

FIG. 1 is a diagrammatic view showing an embodiment of measurement apparatus of the invention for measuring the three dimensions of a parcel;

FIG. 1A is a magnified view of a portion of FIG. 1; and

FIGS. 2A, 2B, and 2C show successive steps making it possible to determine the three dimensions of a parcel using the measurement apparatus shown in FIG. 1.

### DETAILED DESCRIPTION OF PREFERRED EMBODIMENTS

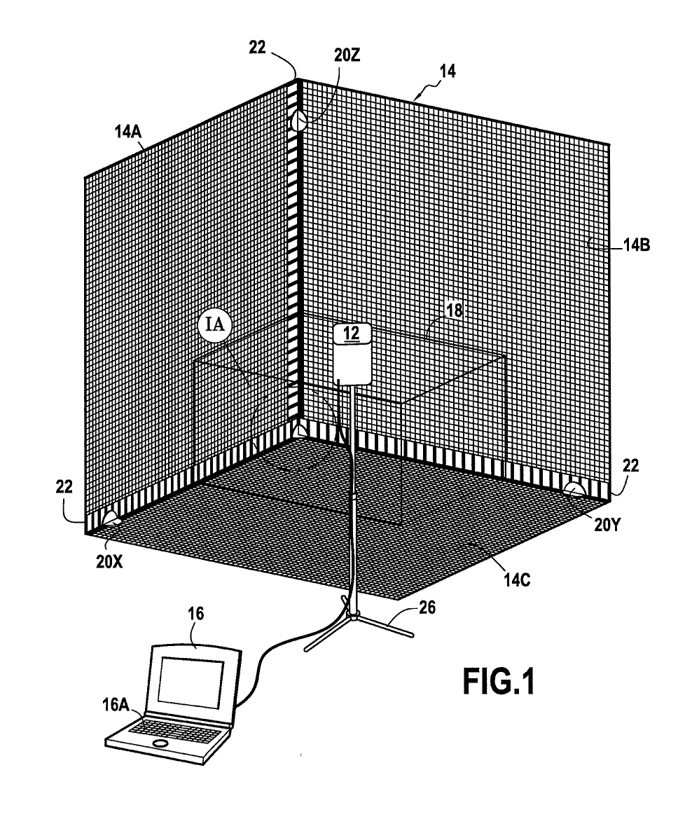

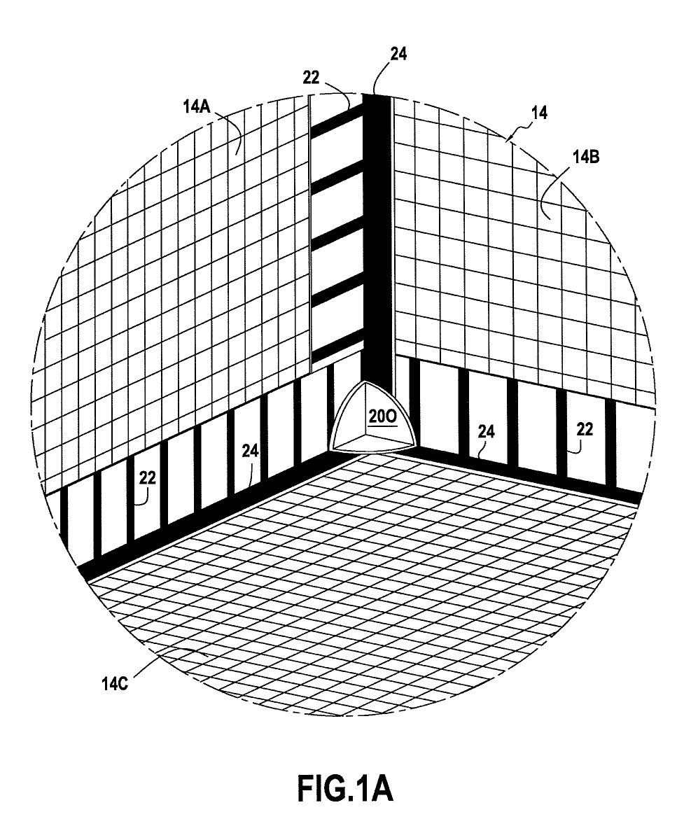

FIG. 1 shows the apparatus of the invention making it possible, at low cost, and by using simple means, to determine the three dimensions (length, width, and height) of a parcel.

This apparatus 10 is constituted by an image sensor 12, by an orthogonal reference support 14, and by a processor unit 16 connected to the image sensor for the purpose of determining the three dimensions of a parcel 18 resting on said support on the basis of its image acquired by the image sensor.

The orthogonal reference support, against the corner of which the parcel to be measured is placed, is made up of three panels 14A, 14B, 14C, made of cardboard or of plastic, and sufficiently rigid to enable the parcel to be held in abutment in said corner, each panel being disposed perpendicularly to the other two panels in such a manner as to define, at their joins, the three axes X, Y, and Z of a three-dimensional rectangular co-ordinate system. The two vertical side panels 14A, 14B are advantageously provided with a grid system of determined dimensions (e.g. formed of 5 mm by 5 mm squares, but cross-shaped or star-shaped marks could also be suitable), it being possible for the horizontal floor panel 14C forming the support surface for supporting the parcel also to have the same grid system, or else for said floor panel to have a plain black background. Towards the end of each of the three axes, substantially at the peripheral outside edge of the orthogonal reference support, there is disposed an end marker 20X, 20Y, 20Z (e.g. two white semicircles having a diameter of 10 mm) serving to define an optical point of reference when it is acquired by the image sensor 12. A final marker 200 is also disposed at the corner at the origin of the three axes. In addition, on either side of each of the three axes, and as shown in the magnified view in FIG. 1A, the following are disposed: a graduated scale 22 (e.g. with graduations every 5 mm) on one side and a plain black strip 24 on the other side. It should be noted that these four individual markers may also be obtained by drawing white lines along each of the three axes, the end of each of the lines forming an end marker and the intersection of the three lines forming the origin marker.

The image sensor 12 is advantageously mounted on a tripod 26, or on any other similar support (column, table, etc.), preferably external to the orthogonal reference support, and optionally raised relative thereto, so as to obtain an image necessarily including at least the three end markers. However, in order not to be too far away from the parcel to be measured, the image sensor (of the charge-coupled device (CCD) type or of the complementary metal-oxide semiconductor (CMOS) type, e.g. a webcam having a resolution of at least two million pixels) is preferably provided with a wide-angle (about) 90° lens and with an autofocus system so as to enable an image to be acquired that is sharp regardless of the dimensions of the parcel, of side in the range 5 centimeters (cm) to 70 cm when considering, for example, a reference support of 80 cm×80 cm×80 cm.

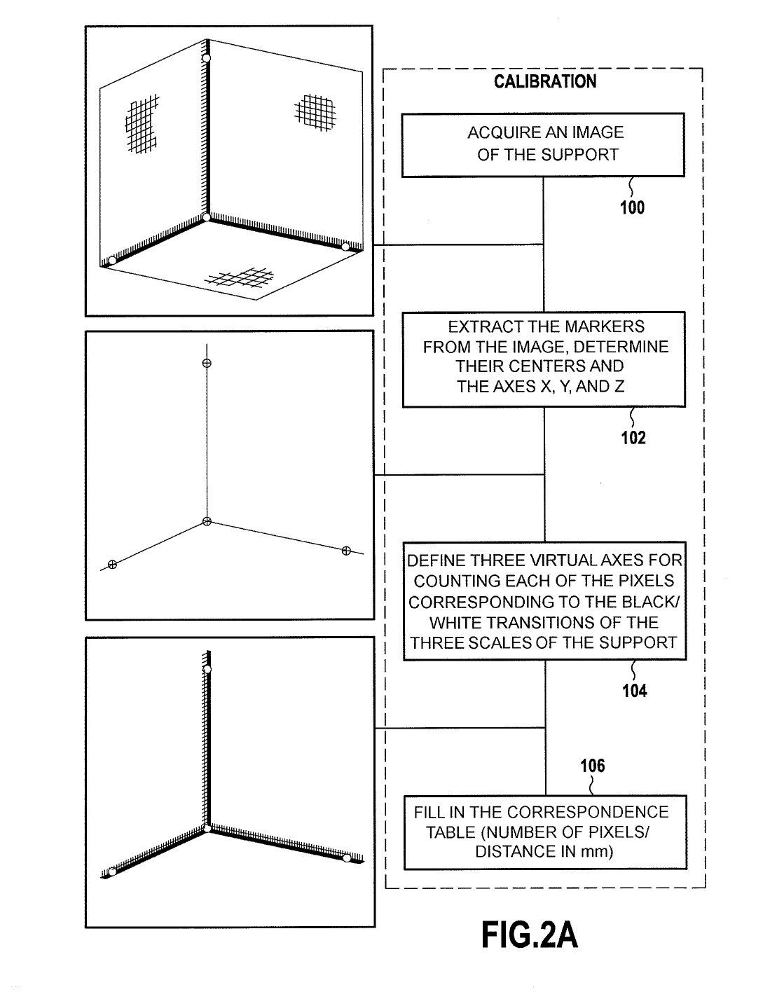

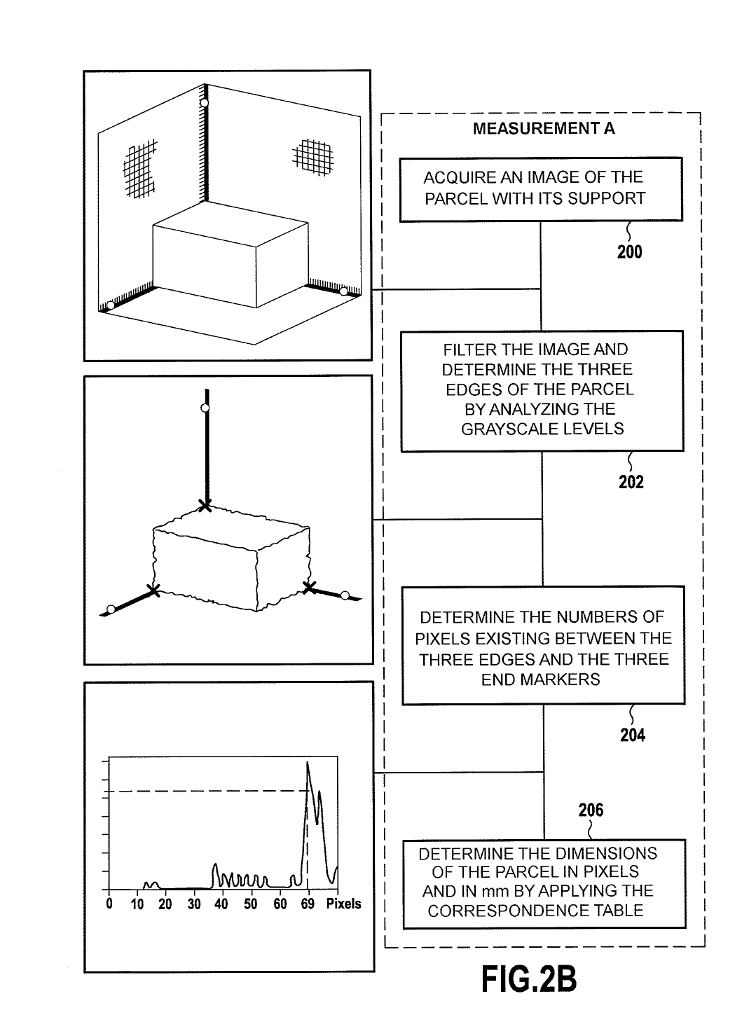

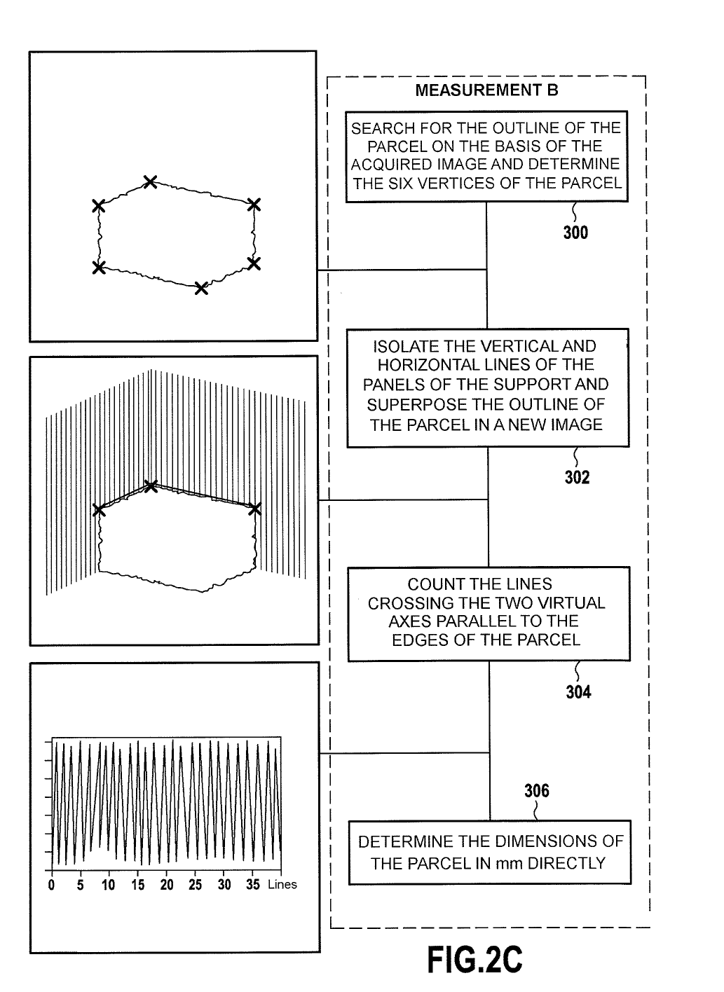

The processor unit 16 may be constituted conventionally by a general-purpose computer of the personal computer (PC) or laptop type, including hardware and software means 16A adapted to acquire and to process images coming from the image sensor 12 so as to determine the three dimensions of the parcel using a particular measurement method that is described below with reference to FIGS. 2A to 2C.

Implementing the method firstly requires a correspondence table to be determined in a stage prior to the method of the invention. For this purpose, in a step 100, the image sensor 12 acquires an image of the orthogonal reference support 14 that bears the four markers and that is then transmitted to the processor unit for analysis in a step 102. In known manner, starting from the black strip 24 of each panel, the grid system of the three panels (or of only two of them if the third is uniformly black) is erased so as to allow to appear only the four white markers 20 in order to determine the center O thereof and the three axes X, Y, and Z interconnecting them (which axes are represented by the three lines interconnecting the crosses in FIG. 2A). In a following step 104, a first virtual calibration line parallel to the axis X interconnecting the centers of the central marker 20O and of the marker 20X is defined virtually and the number of pixels corresponding to each graduation of the scale 22 appearing successively on said line between the two markers is counted. This operation repeated with the other markers for the other two axes Y and Z makes it possible to fill in the correspondence table in a step 106. For example, with a scale graduated every 5 mm, it is possible to obtain the following table, in which a corrector coefficient (pixels/mm) is computed for each graduation as a function of the number of pixels found:

| | X | pixels/ | Y | pixels/ | Z | pixels/ |
|---|---|---|---|---|---|---|
| mm | (pixels) | mm | (pixels) | mm | (pixels) | mm |
| 5 | 6 | 1.20 | 5 | 1.00 | 6 | 1.20 |
| 10 | 12 | 1.20 | 11 | 1.10 | 12 | 1.20 |
| 15 | 18 | 1.20 | 17 | 1.13 | 18 | 1.20 |
| 20 | 24 | 1.20 | 23 | 1.15 | 25 | 1.25 |
| 25 | 29 | 1.16 | 29 | 1.16 | 31 | 1.24 |
| 30 | 35 | 1.17 | 36 | 1.20 | 38 | 1.27 |
| 35 | 40 | 1.14 | 42 | 1.20 | 45 | 1.29 |
| 40 | 46 | 1.15 | 48 | 1.20 | 52 | 1.30 |
| etc. | | | | | | |

Once the table has been filled in in this way, the first measurement stage (A) of the method can be started. For this purpose, the parcel that is to have its dimensions measured is placed against the orthogonal reference support 14, and an image of the parcel also showing the three end markers is acquired by the image sensor 12 in a step 200 and is transmitted to the processor unit 16 for analysis in step 202. The processor unit then defines a first virtual measurement line parallel to the axis X and above the plain black strip 24, and, by means of a conventional image filter (by searching for grayscale levels), determines the first edge of the parcel (represented by a cross in FIG. 2B) crossing this first axis. This operation repeated for the other two axes Y and Z then makes it possible to find the other two edges. The number of pixels found between each edge and the associated end marker then, in a step 204, makes it possible to determine, in pixels, the dimension of the parcel on each axis (because the number of pixels between two markers on the same axis is known), and then to deduce therefrom the value in mm on the basis of the correspondence table, in a final step 206.

However, it should be noted that, when the number of pixels found does not correspond exactly to a number present in the correspondence table, the closest corrector coefficient should be taken in order to obtain the real value in mm (for example, with reference to the preceding table, an edge found at 31 pixels gives a real distance of 31/1.16=26.72 mm).

Thus, in order to determine the three dimensions of a parcel, it is necessary to search for the edges of said parcel along three perpendicular axes and to measure the distance between said edges and markers disposed at predetermined locations. However, it can happen, due to insufficient brightness or insufficient contrast, that the measurements, in particular along the axes X and Y and more rarely along the axis Z, do not make it possible to determine with sufficient accuracy the dimensions of the parcel along said axes. In which case, a second measurement stage (B) is performed making it possible to determine said dimensions nonetheless. For this purpose, in a step 300, on the basis of the image acquired previously and by means of a known outline search method (blob analysis or Hough transform, for example), the outline of the parcel is determined and, with said outline being likened to a hexagon, its six visible vertices (represented by crosses in FIG. 2C) are determined. Then, in a step 302, in known manner, the horizontal and vertical lines of the two vertical side panels 14A, 14B against which the parcel is placed are isolated and superposed in a new image with the previously determined outline of the parcel. Two horizontal virtual axes are then drawn parallel to the two sides interconnecting the top vertices of the parcel and, in a step 304, for each of these two axes, the number of vertical lines crossed (one line corresponding to one interval in the grid system) is determined and the dimensions of the parcel in mm along the corresponding axes are deduced directly therefrom, in a final step 306.

It should be noted that, in practice, the brightness is always sufficient to perform a measurement along the axis Z and thus to determine the height of the parcel during the first measurement stage, so that said second measurement stage is, above all, implemented to determine the width or the length of the parcel in the event of low contrast. It should also be noted that, in such an event, the horizontal panel 14C does not need to be provided with a grid system and can be uniformly black. However, if the lighting configuration is different, the dimension along the axis Z is then obtained by the horizontal (and not the vertical) lines crossing one of the two vertical (and not horizontal) virtual axes formed parallel to the vertical edges of the hexagonal outline of the parcel.

In this method of the invention, the dimensions of a parcel are thus obtained by counting the number of pixels forming the parcel along the three axes X, Y, and Z and by applying to that number a correction coefficient extracted from a correspondence table (number of pixels/mm) and if, due to poor brightness or contrast conditions, this counting is impossible for at least one of said dimensions, then the non-measured dimensions are then obtained merely by counting the number of squares (or of intervals separating the marks forming the grid system) surrounding the parcel. The method can thus be summed up by the following steps:

a. acquiring an image of an orthogonal reference support provided with markers defining the three perpendicular axes of the orthogonal frame of reference, and establishing a correspondence table indicating correspondence between the real distance between said markers and the corresponding number of pixels of the image;

b. acquiring an image of the parcel disposed on the orthogonal reference support;

c. determining the edges of said parcel along three perpendicular axes;

d. if it has been possible to determine the edges in this way, counting the number of pixels forming each of the edges of the parcel, and applying a corrector coefficient taken from the correspondence table so as to obtain the three looked-for real dimensions; and

e. if it has not been possible to determine the edges, at least the edge for one dimension, determining the outlines of the parcel and counting the number of grid system intervals of the orthogonal reference support surrounding the parcel, and obtaining the looked-for missing real dimension.

It should be noted that the steps d and e may also be performed successively in order to ensure that the measurements are valid, a step of comparing the measurements obtained by the two methods then making it possible to determine the dimensions to be taken into account as a function of the specifications of the carrier.

Similarly, it should also be noted that searching for an outline in step e can also be performed prior to or indeed instead of step c in order to determine the positions of the edges of the parcel along the three axes of the orthogonal frame of reference.

What is claimed is:

1. A method of determining the three dimensions of a parcel, in which method the parcel to be measured is placed against an orthogonal reference support made up of at least two perpendicular vertical side panels and having a vertical graduated scale disposed on one of its two adjoining vertical edges, which scale co-operates with two other graduated scales that are horizontal in order to define a three-dimensional rectangular co-ordinate system, each of which other scales is disposed on a horizontal edge of a respective one of said two side panels, which horizontal edges are in contact with a support surface for supporting said parcel, wherein said method comprises the following steps:
using an image sensor to acquire an image of said orthogonal reference support;
using a processor unit to which said image sensor is connected to determine, on the resulting acquired image, a number of pixels corresponding to each of the graduations of said three graduated scales;
in said processor unit, establishing a correspondence table associating each of said graduations with said number of pixels determined in this way;
using said image sensor to acquire an image of the parcel disposed on said orthogonal reference support;
using said processor unit to determine the edges of the parcel along three perpendicular axes; and
using said processor unit to count the number of pixels forming each of the edges of the parcel, and obtaining the looked-for three real dimensions on the basis of said correspondence table.

2. A method according to claim 1, wherein said correspondence table associates each of the graduations with a corrector coefficient equal to the ratio between the number of pixels and a value in millimeters of said associated graduation.

3. A method according to claim 2, wherein the step of using said processor unit to count the number of pixels forming each of the edges of the parcel further comprises applying a corrector coefficient taken from said correspondence table in order to obtain each of the looked-for three real dimensions.

4. A method according to claim 1, wherein, with each of the two side panels further having a uniform grid system that has a predefined interval, it further comprises a step of determining the outlines of the parcel and of counting the number of intervals of said grid system of the orthogonal reference support surrounding the parcel in order to obtain at least one dimension of said parcel.

5. A method according to claim 4, wherein said support surface is formed by a plain horizontal floor panel without any grid system or having a uniform grid system having said predefined interval.

6. Apparatus for determining the three dimensions of a parcel, said apparatus comprising:
an orthogonal reference support made up of at least two perpendicular vertical side panels against which said parcel is placed, and having a vertical graduated scale disposed on one of its two adjoining vertical edges, which scale co-operates with two other graduated scales that are horizontal in order to define a three-dimensional rectangular co-ordinate system, each of which other scales is disposed on a horizontal edge of a respective one of said two side panels, which horizontal edges are in contact with a support surface for supporting said parcel;
an image sensor for acquiring an image of said parcel against said orthogonal reference support; and
a processor unit connected to said image sensor for the purpose of determining the three dimensions of said parcel on the basis of said image acquired in this way;
wherein, on the basis of an image of said orthogonal reference support, said processor unit determines firstly a number of pixels corresponding to each of the graduations of said three graduated scales and secondly the edges of the parcel along three perpendicular axes;
and said processor unit includes a correspondence table associating each of said graduations with said number of pixels determined in this way, so as to obtain said three dimensions of said parcel on the basis of a number of pixels corresponding to each of said edges of said parcel.

7. Apparatus according to claim 6, wherein said correspondence table includes a corrector coefficient associated with each of said graduations and equal to the ratio between said number of pixels and a value in millimeters of said associated graduation.

8. Apparatus according to claim 6, wherein each of said side panels further has a uniform grid system having a predefined interval.

9. Apparatus according to claim 8, wherein said support surface is formed by a horizontal floor panel having a uniform grid system having said predefined interval.

10. Apparatus according to claim 8, wherein said support surface is formed by a plain horizontal floor panel not having any grid system.

11. Apparatus according to claim 6, wherein said image sensor is a webcam provided with a wide-angle lens and with an autofocus system.

12. Apparatus according to claim 6, wherein said processor unit is constituted by either one of the following units: a general-purpose computer; and a laptop computer.

13. A mailpiece franking system including apparatus for determining the dimensions of a parcel according to claim 6.
